(19) United States
(12) Patent Application Publication
(10) Pub. No.: US 2004/0074216 A1
(43) Pub. Date: Apr. 22, 2004

(54) Extension means connecting an axle to the engine of the lawn mower for driving the vehicle

(76) Inventor: Chien-Tai Chen, Taipei (TW)

Correspondence Address: BIRCH STEWART KOLASCH & BIRCH, PO BOX 747, FALLS CHURCH, VA, 22040-0747, US

(21) Appl. No.: 10/653,167

(22) Filed: Sep. 3, 2003

(30) Foreign Application Priority Data
Sep. 26, 2002 (CN) 02 2 54970.6

(51) Int. Cl. A01D 34/03

(52) U.S. Cl. 56/10.1

(57) ABSTRACT

An extension means connecting an axle to the engine of the lawn mower for providing the power to drive the vehicle comprises a flange seat having a plurality of fastening holes at the seat; and an axial rod at the central of the seat; wherein the axial rod includes a screw thread at the end and a face gear is next to the screw thread.

### BACKGROUND OF THE INVENTION

1. Field of the Invention

The present invention relates to a power using the engine of the lawn mower to drive the vehicle, more particularly, and to an extension means connecting an axle to the engine of the lawn mower for providing the power to drive the vehicle.

2. Description of the Related Art

The transport is used in large factory to save the time of walking. The ministry of transportation does not control this kind of transport so the power system is different from the vehicle used in the highway. Presently, the electric vehicle always uses the larger factory to transport different factories at the same field, but the charge capacity of the electric vehicle is big problem so that the electric vehicle could not be used at long distance. Further, the charge equipment and capacitor is expansive in the maintain fee.

The lawn mower usually uses to weed the garden, and the power is from the petrol engine. The petrol engine pushes the power output apparatus which connects a driving shaft to reels, and the reels could generate high speed spin to weed. Therefore, the lawn mower only uses to weed and could not generate torque to transport like cars.

### SUMMARY OF THE INVENTION

To save the above mentions of disadvantages the present invention discloses an extension means for an axle. The electric vehicle usually uses to transport between different factories. If uses the gas vehicle, the air pollution and the cost are big problems than the electric vehicle.

The present invention discloses using an engine from the lawn mower to drive a vehicle, but it does not add any engine or modify the engine structure and just change the connecting member to the engine. The present invention discloses an engine of the lawn mower to load or pull something. Further, using an extension means connecting an axel to the engine of the lawn mower. Using the power of the engine from the lawn mower drivers the extension means to power an accelerator generating the torque for loading or pulling something. And, the extension means is disposed on a driving apparatus of the engine by a plurality of fastening holes of a flange seat of the extension means. Further more, the central of seat has an axial rod having a screw thread at the end and being next to a face gear to gear the accelerator and being fastened by a fastening member.

Using the extension means on the engine from the lawn mower could drive the power to be generated the different torque by the accelerator and makes the machine moving like gas vehicle, and the displacement of the engine of the lawn mower is lower 48 c.c. which is under control by the ministry of transportation. The present invention just changes the conventional engine of the lawn mower structure but not figure out the new engine used.

It is to be understood that both the foregoing general description and the following detailed description are exemplary, and are intended to provide further explanation of the invention as claimed.

### BRIEF DESCRIPTION OF THE DRAWINGS

The accompanying drawing is included to provide a further understanding of the invention, and is incorporated in and constitutes a part of this specification. The drawing illustrates an embodiment of the invention and, together with the description, serves to explain the principles of the invention. In the drawing,

FIG. 1 is a side view showing an extension means of the present invention;

FIG. 2 is a schematic view showing the extension means assembling with the accelerator and the lawn mower of the present invention; and

FIG. 3 is a schematic view showing the driving state of the extension means and the lawn mower of the present invention.

### DETAILED DESCRIPTION OF THE PREFERRED EMBODIMENTS

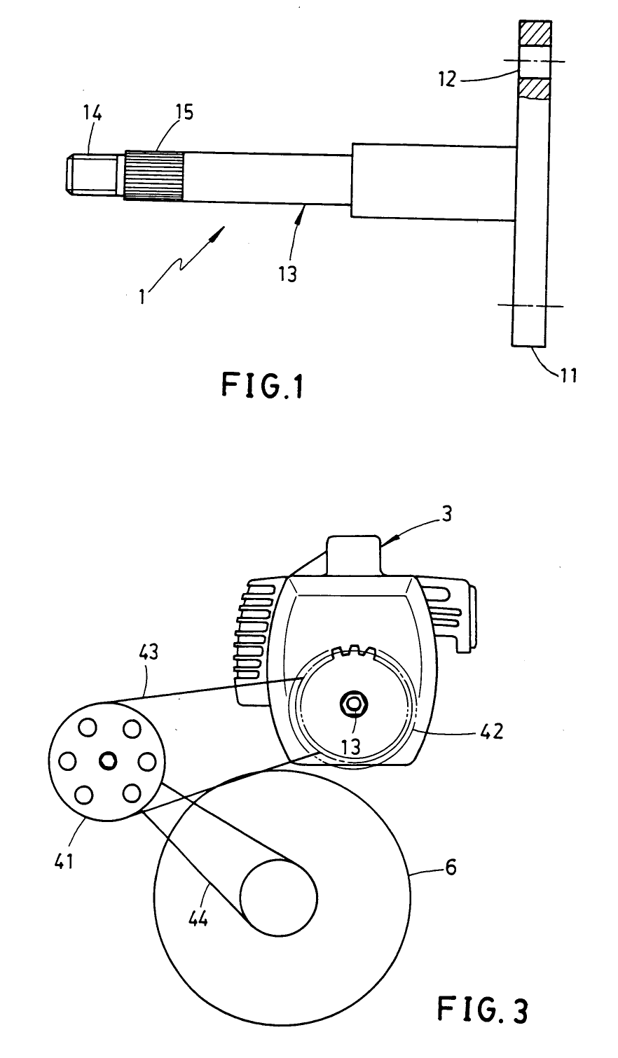

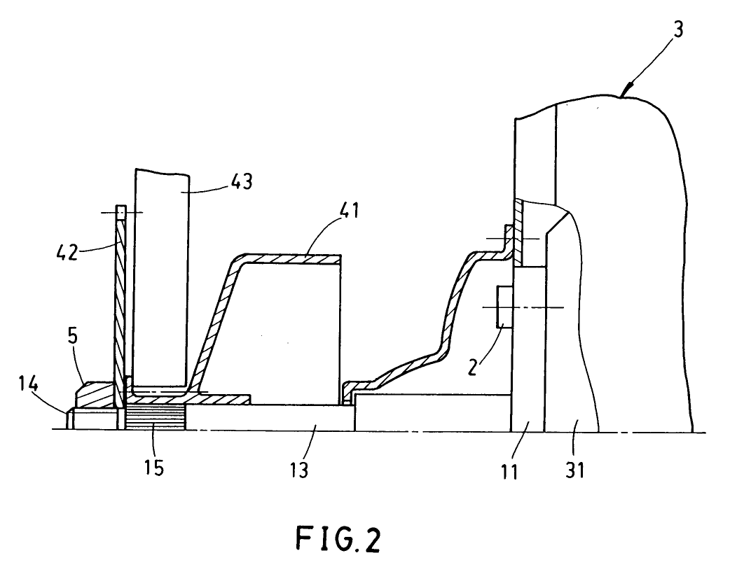

Reference will now be made in detail to the preferred embodiments of the present invention, examples of which are illustrated in the accompanying drawings. Wherever possible, the same reference numbers are used in the drawings and the description to refer to the same or like parts. Refer to FIGS. 1 to 3, an extension means 1 for an axle of the present invention comprises a flange seat 11 having a plurality of fastening holes 12 and an axial rod 13 disposes at the central of the seat 11 which has a screw thread 14 at the end and is next to a face gear 15. The extension means 1 is coupled to a driving apparatus 31 of a lawn mover 3 by the fastening holes 12, and the axial rod 12 passes through an accelerate plate 41 and a plate 42 of a accelerator which are fastened on the screw thread 14 by a nut 5. The extension means 1 power the accelerator which drives the wheels 6 by a first belt 43 and a second belt 44 to let the wheel to move. So, the lawn mower 3 can move by the conventional engine.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. An extension means connecting an axle to the engine of the lawn mower for driving the vehicle comprising:
a flange seat having a plurality of fastening holes at the seat; and
an axial rod at the central of the seat;
wherein the axial rod includes a screw thread at the end and a face gear is next to the screw thread.

2. The extension means as claim 1, wherein the flange seat is fastened on a driving apparatus of lawn mower by a fastening element.

3. The extension means as claim 1, wherein the extension is made by one mold.
